(19) United States
(12) Patent Application Publication
(10) Pub. No.: US 2017/0193736 A1
(43) Pub. Date: Jul. 6, 2017

(54) RANDOM OUTCOME CUSTOMER AWARDS

(71) Applicant: Brittney Rose Martino, Las Vegas, NV (US)

(72) Inventor: Brittney Rose Martino, Las Vegas, NV (US)

(21) Appl. No.: 15/376,347

(22) Filed: Dec. 12, 2016

Related U.S. Application Data
(60) Provisional application No. 62/275,234, filed on Jan. 5, 2016.

(51) Int. Cl. G07F 17/32

(52) U.S. Cl. CPC G07F 17/329; G07F 17/3225; G07F 17/3244; G07F 17/3272

(57) ABSTRACT

A method and system provides game tickets on a wager to a game administrator. A player provides a wager to a game administrator; the game administrator provides blank game cards of a 3×3 grid of frames into which sports game event outcomes can be inserted. The game administrator provides sufficient sports game outcome predictions to the player to be able to fill nine squares in the 3×3 grid to create a completed ticket. The player directs placement of at least one up to at least 9 of the sports game outcome predictions into frames on the grid. The game administrator identifies winning or losing outcomes of the wager on the completed ticket based on a comparison of real life information and the sports game outcome predictions in frames on the grid.

### RELATED APPLICATION DATA

This application claims priority from provisional U.S. Patent Application Ser. No. 62/275,234, filed 5 Jan. 2016, titled “RANDOM OUTCOME CUSTOMER AWARDS.”

### BACKGROUND OF THE INVENTION

1. Field of the Invention

The present invention relates to the field of fantasy football, customer or consumer awards in the form of tickets, icons or electronic images that offer a potential value depending upon outcomes in events. Methods of providing the customer or consumer input into the ticket selected are also enabled.

2. Background of the Art

In modern commerce, it has become important for stores, events, restaurants, theaters, venues and other consumer-oriented businesses to provide client recognition and to provide clients with rewards or potential awards to stimulate their loyalty and business. One common practice is to award stamps, coupons, stickers or game pieces to customers that make purchases or particular purchases. An example of this is the MacDonald's contests (e.g., Monopoly® board game) and in 2012, an Olympic Games® event game ticket. In the latter, upon purchase of special items, game tickets were given to the client identifying specific winning outcomes, such as either a particular National Team event (e.g., U.S. Men's gymnastic team), particular event and country (e.g., Canada 1000 m men's race cycling) or an individual or individual in a specific event (e.g., Australia women in the 200 m butterfly, or Michael Phelps in the Men's 200 m Individual Medley, or Missy Franklin, Bronze medal in the Women's 100 m Backstroke). These tickets were generally given out weeks or days before the events took place, increasing the possibility of their being lost before the potential for value or determination of no value was made. Also, the tickets were randomly provided with no client input as to general event selection (all tickets were for the 2012 Olympic Games® events), specific variety of sports event (tickets were randomly provided without any capability of selecting a particular sport event (e.g., swimming, equestrian events, track and field, water polo, etc.). This can reduce the interest in the client who might not appreciate competition in the event on his/her card, such as boxing. Additionally, because the tickets had little relevance to real time events, such unforeseen events such as countries pulling out of or being barred from the Olympics, or injuries to players well in advance if the events removed any interest in certain picks.

Other award programs can be performed on-line or at point of sales. For example, Published U.S. Patent Document No. 20140229263 (Edelman) discloses a method of providing a loyalty rewards program, comprising receiving an electronic order for a purchase of goods or services from a personal communication device operated by a consumer over a communication interface, determining a location of the personal communication device, electronically awarding rewards points by a processor to an account associated with the consumer stored in memory based on purchases of goods or services placed through the personal communication device by the server only if the personal communication device is located at a merchant's premises, the merchant authorized to participate in the loyalty rewards program.

Published U.S. Patent Application Document No. 20140222540 (Shepard) discloses a platform for a loyalty program provides an interface allowing a consumer to create a benefit tailored for his/her needs. In one embodiment, a consumer accesses the platform via a web-based interface, and selects benefit/reward parameters including but not limited to the nature of the event triggering award of the benefit, the source (i.e. retailer) of the benefit, the nature of the benefit (i.e., discount based upon purchase price or accumulated loyalty points), and/or the events allowing accrual of loyalty points. The interface communicates the inputted parameter to an engine of the loyalty program. The platform would then check the inputted parameter against any constraints, such as parameters of an existing loyalty program in which the consumer is already enrolled.

Published U.S. Patent Application Document No. 20140222533 (Ovick) discloses an individualized price offer is associated with the account information of a user in a data warehouse coupled with a transaction handler of a payment processing network. If the individualized price offer is applicable for a pre-authorization of a purchase, information about the price offer is communicated to a transaction terminal via an authorization response for the pre-authorization. The transaction terminal is configured to adjust the published price in accordance with the information about the price offer such that the user is presented with an individualized price at the transaction terminal before the user starts receiving the product or service. After the purchase, the transaction terminal computes the transaction amount according to the individualized price and request clearing and settlement of the transaction according to the transaction amount computed according to the individualized price.

Published U.S. Patent Application Document No. 20140228088 (Katz) Methods and systems for electronic interaction comprising a display for presenting a grid of identifying objects, an input for receiving a player selection of an identifying object, a random generator for randomly selecting a winning identifying object, and a point tally system for awarding points to the player according to the rules comprising a first point value if the player selected identifying object exactly matches the winning identifying object, a second point value if the player selected identifying object is in a geometric relationship with the winning identifying object, and a third, negative, point value if the player is not awarded the first point value or the second point value.

Published U.S. Patent Application Document No. 20140057707 (Paulsen) discloses data processing apparatus, systems, and methods implemented over a gaming network for providing for disposition of promotional offers in a wager-based gaming environment. A monitoring engine receives an identification of a promotional offer as having an unredeemed status. A determining engine determines that the promotional offer having the unredeemed status satisfies one or more parameters to designate the promotional offer for an auction. Such designation is independent of real-time wager-based game play in the gaming network. An auction control engine provides the designated promotional offer as an item to be auctioned in the wager-based gaming network.

Published U.S. Patent Application Document No. 20130035149 (Oakes) describes systems and methods for retail lottery-style games. In one particular exemplary embodiment, a map-based lottery game is established, by at least one processor, that is scheduled to have a lottery drawing, where the map-based lottery game includes a gameboard made up of a plurality of units each selectable to represent an entry in the lottery game. In addition, a plurality of game entries are received each identifying a unit on the gameboard either with an identifier of the unit or with a lottery combination corresponding to the unit and, at least one winning entry from the plurality of game entries is selected by selecting among the plurality of units on the gameboard or among the units identified by the plurality of game entries.

Published U.S. Patent Application Document No. 20120270642 (Manfredi) describes a gaming machine award system that acts over a gaming machine network having a plurality of gaming devices coupled thereto. The award system includes a bonus server coupled to the network and having stored thereon a trigger condition. A game play tracker tracks game play across the network of gaming devices and detects an occurrence of the trigger condition. The bonus server sends out a selection signal over the network to a selected gaming machine responsive to the detected trigger condition. A printer associated with the selected gaming machine is structured to generate a mystery ticket printed output responsive to receipt of said selection signal including machine-readable indicia corresponding to a record of value stored at the bonus server, and human readable indicia that indicates only a range of possible values of the ticket but not a specific value. The printed ticket is a cashless instrument that may be redeemed or played per the nature and characteristics of the award given with the specific value awarded to the player.

Published U.S. Patent Application Document No. 20120061951 (Upshaw) discloses systems, methods, and lottery tickets provide lottery games with gameplay that allows a variety of play options and results a rich prize structure. Gameplay can be centered on a lottery game player or a related entity, which can comprise other lottery game players. Gameplay centered on the lottery game player can be customized to a specific segment associated therewith. Play options can include iterative gameplay and gameplay reliant on information supplied by the game player. Features of the rich prize structure include monetary prizes that can include cash awards and non-cash awards. Monetary prizes can be awarded in response to active game play or passive gameplay. Other monetary prizes can be redeemed during a period of time and can include award terms that benefit the lottery game player or the related entity (relative(s) of the lottery game player, non-profit organization(s), prize supplier(s), etc.). In spite of the potential interest of these gaming systems, which disclosures are incorporated by reference in their entirety, a more interesting and effective award system is still needed.

### SUMMARY OF THE INVENTION

A method and system provides random potential award identifiers to users without purchase by:
a) a primary client enabling provision of game cards having a potential for obtaining awards based on random event outcomes;
b) the primary client establishing a supply system for the users to obtain the game cards;
c) the user engaging in the supply system and obtaining a unique is identification code enabling access to a client controlled source of game cards;
d) the user accesses a distal server and enters the unique identification code;
e) the distal server provides a randomly generated game card having a potential for obtaining awards based on random event outcomes without the user exchanging value to obtain the randomly generated game card;
f) information provided to the distal server of random event outcomes; and
g) the server identifying winning or losing outcomes based on a comparison of information content identified on the randomly generated game card and the random event outcomes.

### BRIEF DESCRIPTION OF THE FIGURES

FIG. 1 illustrates one embodiment of a system for providing award cards, award tickets and/or accumulated value from winning event outcomes, which might otherwise be considered as incentive rewards or loyalty points, to consumers who are located on the premises of a merchant participating in a reward program;

FIG. 2 is a functional block diagram of one embodiment of one of the servers shown in FIG. 1 in an embodiment where the server acts as a rewards points server and another server acts as a point-of-sale server;

FIG. 3 is a functional block diagram of one embodiment of one of the personal communication devices shown in FIG. 1.

FIG. 4 is a screen shot of an electronically created complete ticket.

FIG. 5 is a paytable/odds table for one event system within the scope of the present generic technology.

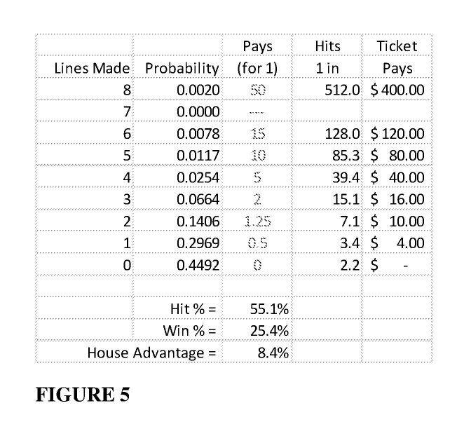

### DETAILED DESCRIPTION OF THE INVENTION

A method and system provides random potential award identifiers to users by: a) a primary client enables provision of game cards having a potential for obtaining awards based on sports event outcomes; b) the primary client establishing a supply system for users to obtain the game cards; c) the user engaging in the supply system and obtaining a set of at least nine game event predictions provided by a processor to a player input system; d) the user accesses the player input system and retrieves the at least nine game event predictions; e) the player inserts one game event outcome into each of nine frames in a 3×3 grid, and the ticket with all nine game event outcomes inserted in the grid is issued to the user as a ticket game card having a potential for obtaining awards based on real life game event outcomes; f) information on the real life game event outcomes is provided to the distal server of random event outcomes from a reliable source of real life sports game event information; and g) the grid content of the ticket is compared to the real life sports game event outcomes, and prizes are made available to the user based upon at least one line of 3 grids is filled with a sports event outcome that is satisfied by the real life game event outcomes. The grids, even when referenced as 3×3, includes larger grids, such as 3×4, 4×4, 4×5 and 5×5, with payouts available for at least 3 winning events in aa row, at least four winning events in a row or at least 5 winning events in a row, with multiple rows being available for payouts.

In practicing the present technology, one of the embodiments enables the player to select X number of games from a list of ≧X games that are provided to the players through an electronic format, terminal or a kiosk with an electronically verifiable electronic ticket or a printed marked paper ticket that may be later input is to a scanner device in communication with a main processor/distal server to produce a final paper ticket and/or resolve the wager after events. After the three games are over, the players would redeem the ticket for determination of the winning outcomes. Printed tickets may be filled in, then scanned, then verified and/or a final server directed game ticket is issued.

The game may also be designed so that the published spreads for each game are locked in when the ticket is purchased (so that if the official spread for one or more games changes after the ticket is purchased, the spread on the purchased ticket remains the same).

A server may be used to provide the at least nine sports game event outcomes from which a user/player may make selections, the user/player strategically placing the available selections in boxes/frames in the grid to select what is felt to be optimal placements. For example, if the player feels one of the available selections is a best choice, that selection might be placed in the center frame in the 3×3 grid. Likewise, if one of the selections is a least favorite selection, that might be placed in the middle square in an outside line. The frames/squares/boxes in the 3×3 grid shall be named, for purposes of the present description as three vertical columns from left-to-right names Column A, Column B and Column C. There are three horizontal rows going from top-to-bottom as Row 1, Row 2 and Row 3. Therefore the nine frames/boxes/squares in the grids are numbered A1, A2, A3, B1, B2, B3, C1, C2 and C3.

A server is used to provide the available selections. The server may have access to publicly available game event lines (e.g., a team will score x-points more than another team; a player will have a certain percentage of success; a player will have at least or less than an absolute number value of points; a team will have possession of a scoring position for at least y-amount of time and the like. Alternatively, some or all of the available game event lines (e.g., number of pitches by a baseball player, number of hits allowed by a baseball player, total distance of field goals kicked by a football player, number of birdies by a golfer; number of aces—for or against—a tennis player, number of saves by a goalie, number of 3-pointers by a basketball player, number of foul shots made by a basketball player, number of penalties on a team or in the game, etc.) may be randomly generated within a reasonable range and provided as the at least 9-outcomes for selection. In this manner, some of the individual available outcomes for positioning in the grid may be apparently extremely good or extremely bad. This is why a range would be provided. That range could be independent or blended with any publicly available line. For example, if it was published in the newspapers that Cornell was favored by 6.5 points over Dartmouth in football for a specific game day, the random event generator might be allowed a range of selections for that game event outcome between a range of Cornell by 5-8 points, or 6-7 points, with a specific point spread within that range selected. Therefore, different cards may have different spreads within a rational; range.

Players may be required to have grids with multiple different sports included, or may be allowed to specific a single sport or multiple sports from which individual selections will be provided by the server. Upon provision of the at least nine available selections, the player/user will either position nine of the individual selections in the nine grids, or possibly by default (based on excessive time or player election), the processor will randomly position nine of the available selections into the nine boxes/squares/frames.

It is necessary that at least nine outcomes be used in the filling of the grid. This can be done by providing exactly nine, more than nine or fewer than nine outcomes for selection. When fewer than nine outcomes are provided for selection and placement, the processor/server may automatically fill remaining squares after the player/user has exhausted the fewer than nine available selections. Generally, the player/user must use all of his available selections (up to the nine) to complete filling out of the card. Where the processor may additionally provide selections, a player may decline to use one or more of the available selections and take her/his chances on the processor/server providing a better selection.

Additionally, if, for example, 10 selections were made available, a player/user might pay an additional amount in an underlying wager to have two selections in a single frame. This would probably require a reduction in available payouts for that card, because of the increase chances of having more winning 3-grid line outcomes because of the increased number of wins available in those lines with the frame having two selections in it. Alternatively, the presence of two event outcomes in a single square might provide for a higher payout table if a winning outcome would require that both selections in the single frame be successful and that frame was further included in a successful three-frame line.

The method and system is especially effective wherein the information content is selected from random event outcomes that are random or partially directed sports event outcomes or statistics that are of a relatively immediate outcome nature. By random sports outcomes are meant there is a processor (local or distal) that accesses a data base on at least one but preferably more than one sports events such as games, or halves or innings, or quarters or event individual plays (next at bat, next series of downs, next play, next field goal attempt, next possession, etc.) as with professional or collegiate baseball, football, soccer, hockey, horse racing, automobile racing, track and field and other competitive sports. “Partially directed” sports events means that a client may select a particular sport, particular sport event or particular game on which the processor will access a data base and select random events, the outcomes of which will be used to determine potential value for a physical or electronic ticket. “Relatively immediate” means that the outcome of the randomly selected event(s) will be determined in a time frame commensurate with the business that is providing the physical or electronic tickets. For example, the longest time period within a relatively immediate framework may be 24 hours (might be a week for a parlay card, for a week of football games, etc.), but more likely, as with a theme park or stadium, a relatively immediate time frame may be events that are absolutely concluded within a next 12 hours, or within a next six hours. For shorter duration business models, such as theaters, restaurants, malls, outlets and the like, a relatively immediate time frame may be less than 12 hours, such as less than 9 hours, less than 6 hours, less than 5 hours, less than 4 hours, less than 3 hours, less than 2 hours, less than 90 minutes, less than 1 hour or even less than 30 minutes. The time interval is significant in overcoming the problems of providing outcome tickets that are pre-printed well in advance of potential events. For example, if tickets had been printed before the 1980 Olympics, the boycott by the (then) USSR, would have substantially invalidated tickets where a Russian athlete was on the ticket, or increased the probability for an athlete whose importance increased because of the absence of Russian competitors. As such tickets would have been made with a predictable percentage of wins versus losses, events changing so far after issuance of the tickets can dramatically change award levels.

By accessing an electronic data base of sports information, especially those with live feeds of sports data, outcome results of events in near real-time play can be reported, and where a particular event is accessible by visual viewing (by television, live streaming or other display, including live attendance), customers can observe events and enjoy the excitement of at least one of their randomly selected events on which an outcome can determine a winning outcome on their ticket. For example, the ticket may indicate one or more events on which a winning outcome will be determined.

An award may be based upon successful outcomes on events, with rewards or higher levels of awards provided with increasing numbers of successful event outcomes.

Paytables may be provided wherein, reported in either absolute amounts or multiples of an amount wagered, one successful 3-frame line would pay 1:1 or 1.5:1 or 2:1, two successful 3-frame lines would pay 2:1, or 2.5:1 or 3:1 etc. (wherein complexity or difficulty of selections being a possible basis of modifying the paytables, such as a golfer having at least 5 birdies, no more than 1 bogies, and no eagles in a round).

Some of the selectable sport game event outcomes might be contradictory, such as Twins win by 3 and Yankees win by 1 (when they are playing each other) as separate event outcomes determining the ticket overall outcome (on the same ticket or not. The selection of random events or outcomes available for positioning in the grid is done without the player/user being allowed to create the specific event outcomes or statistic. Preferred client selectable fields are a general field selected from the group consisting of football, basketball, baseball, hockey, soccer, golf, and tennis, including women's events, professional events, amateur events and collegiate events. As noted above, the method may use event outcomes or statistics within the general field that must be determined within a reasonable time frame. In rare circumstances the relatively immediate time frame may be a single week of play for football, a weekend total of baseball games, and may be required to have a final determination within 48 hours, 36 hours, 24 hours and the like from the issuance of the ticket (or maybe up to a week as for the above mentioned football week, with the tickets or coupons given within two days before the beginning of the next football week in a season). As previously noted, event outcomes or statistics within the general field preferably will be determined within 24 hours of award of random game cards (although not if it is for football games that might span a week, although this is a less preferred embodiment for reasons provided herein). The primary client may be a retailer, wholesaler, restaurant, theater, sports venue operation, stadium, track, pool, university, school or online sales business (it might also be a sports venue operator, for example the owner of a sports team or venue doing a promotion for fans at the stadium, arena, track, etc.

The method may be practiced where the user selects and/or resolves the randomly awarded game ticket by online communication to the game server after conclusion of the random event outcomes and resolution of winning outcomes is provided by online downloadable (virtual electronic) or printable coupons that can be redeemed (again as long as this not limiting to the only method of resolving a winning ticket), or by scanning a bar code or QRL on the ticket.

The term “real time” (in the practice of the present technology) is not as literal as real time is interpreted in conventional electronics systems. The term in the practice of the present technology indicates a range, which may even be a ± range of relatively short time (e.g., up to and including a full tournament schedule as with the NCAA Basketball tournament, the World Series, a golf tournament, a week of football, etc.), such as 24 hours or less, a single calendar day, 12 hours or less, 8 hours or less, 6 hours or less, four hours or less, 2 or 3 hours or less, and the like, possibly in a ± spread. This enables customers on a college football game day to be able to enter the ticket award event even though they are not present at the start of a first game for the day. As the events chosen are random, and there is no player input or suggestion, the one or more events in the ticket producing an award can be selected by the processor after one or more of the events has begun, or even ended.

The tickets may be delivered physically or electronically through or at the live sporting event upon which the promotion is based. It is possible, for example, for beer vendors to scan beverage purchases on credit cards, and the credit card company can issue an electronic ticket (preferably with an additional cash amount or charge as a wager) through an app associated with the credit card and the credit card owner's cell phone or pad. Actual game cards or tickets can be relatively novel in their own right, because of content or events. The games may be played as a more social or one-one-one competitive event, with a tabletop system, with opposing players.

The present disclosure relates to a variety of embodiments related to apparatus and methods of providing an on-site or even distal awards program to players/users. The awards program refers to an award program that provides awards only through game tickets or games cards at least partially filled into a 3×3 grid by the player/user making a wager.

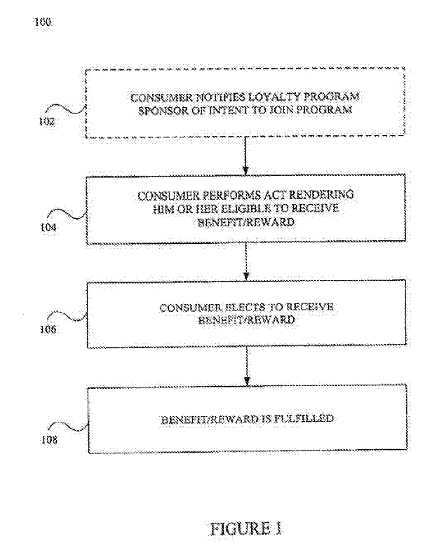

FIG. 1 illustrates one embodiment of a system for providing rewards points, otherwise known as incentive rewards or loyalty points, to consumers who are located on the premises of a game ticket provider such as a casino, off-track betting site, merchant, hotel, sports venue operator, stadium, arena, restaurant, store, outlet, mall, and the like.

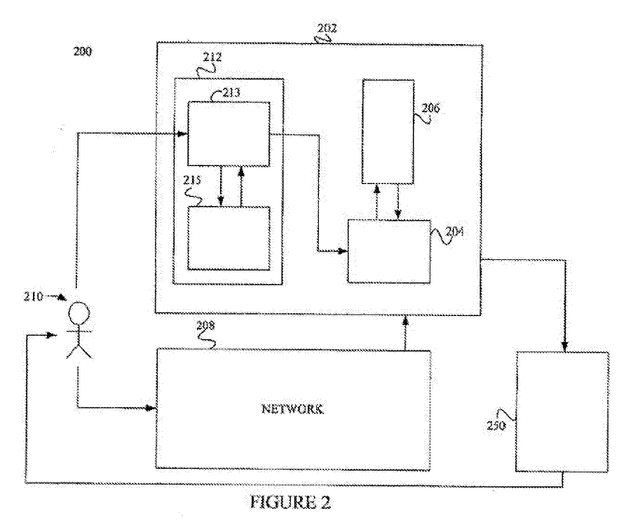

Referring to FIG. 1, consumers each may purchase goods or services from merchants participating in the rewards program using a respective personal communication device 100a, 100b, or 100c. In FIG. 1, each of the personal communication devices 100a, 100b, or 100c are shown located at a participating merchant location 102. For example, each personal communication device may be carried by a respective owner/consumer into a bar, restaurant, sporting event venue, spa, or almost any other merchant of goods or services. The personal communication devices typically comprise a smart phone, such as an iPhone 5 manufactured by Apple Computer, Inc., of Cuppertino, Calif. or a Galaxy S III manufactured by Samsung Electronics of Seoul, South Korea. In other embodiments, personal communication devices may comprise a laptop or tablet computer. In any case, any device may be classified as a personal communication device if it comprises an ability to communicate wirelessly and is able to process purchases for goods or services on behalf of a consumer. Often, the personal communication devices are owned by a single consumer, such as the case where a smartphone is owned by a single person and is generally used exclusively by that person. One or more of the personal communication devices may communicate with a wireless router/modem 104 located on the premises of merchant 102. Wireless router/modem 104 comprises one of any number of commonly available wireless router/modems on the market today, such as a Linksys Smart Wi-Fi Router N600 manufactured by Cisco Systems of San Jose, Calif. Wireless communication signals are passed through router 104 to/from server 106, shown as being located at the merchant 102 location. However, in another embodiment, all or a portion of the services offered by server 106 could be located in a location away from merchant 102, as shown as server 108. For example, in one embodiment, server 106 may offer consumers located on the premises of merchant 102 the ability to order food or drinks, play a musical or video selection on a jukebox or video display located inside the premises of merchant 102, or to play or participate in electronic game play, either individually, or with/against other consumers, while server 108 operates as a game ticket provider or server that issues reward game tickets for electronic or physical delivery to consumers as they purchase goods or services via their personal communication devices while they are located on the premises of the merchant or other participant. A game card account may be created and stored at either server 106 or server 108 to reflect an award balance as awards points are accumulated by each consumer as purchases are made and winning outcomes occur, and to reduce the award balance as consumers use their awards to make future purchases. If server 108 is used, it may communicate with personal communication devices located at merchant 102 via a wide area network 110, such as the Internet, through wireless router/modem/modem 104 located at participant or merchant 102, through server 106 (if used), and then through wireless router/modem 104. Alternatively, or in addition, server 108 may communicate with personal communication devices via a wide area network 110, cellular network 114, then directly to the personal communication devices via a wireless link. In yet another embodiment, server 108 may communicate with personal communication devices cellular network 114 and then to the personal communication devices via a wireless link. In any case, game cards or game tickets (physical or electronic) are awarded to consumers as they purchase goods or services via their personal communication devices only if they are located at a merchant that participates in the rewards points program. Additionally, consumers may, in one embodiment, order goods or services from merchant 102 even if they are not located on the premises of merchant 102, however they are not necessarily given game cards or game tickets for doing so unless they are associated/linked to the promotion through an app or membership. For example, a consumer operating personal communication device 100a may be at home and play a game offered by merchant 102 for a fee or select a musical or audio-visual entertainment selection offered by merchant 102 by accessing server 106 via cellular network 114 which is in communication with server 106 as described above. The location of a personal communication device may be determined by one or more methods, as described in further detail below. FIG. 2 is a functional block diagram of one embodiment of server 108 in an embodiment where server 108 acts as an awards card server or game ticket server and the server 106 acts as a point-of-sale server that receives purchase orders from consumers via personal communication devices and router 104. It should be understood that server 106 typically comprises the same or similar functionality, hardware, and software as server 108.

Specifically, FIG. 2 shows processor 200, memory 202, communication interface 204, and user interface 206. It should be understood that not all of the functional blocks shown in FIG. 2 are required for operation of server 108 (for example, user interface may not be necessary), that the functional blocks may be connected to one another in a variety of ways, and that not all functional blocks necessary for operation of server 108 are shown (such as a power supply), for purposes of clarity. Server 108 may comprise virtually any commercially-available servers on the market today, including the P4300IP server system manufactured by Intel Corporation of Santa Clara, Calif.

Processor 200 provides general operation of server 108 by executing processor-executable instructions stored in memory 202, for example, processor-executable code. Processor 200 typically comprises a general purpose processor, such as any of the Xenon® family of processors manufactured by Intel Corporation of Santa Clara, Calif., although any one of a variety of microprocessors, microcomputers, and/or microcontrollers may be used alternatively. Memory 202 comprises one or more information storage devices, such as hard drives, RAM memories, ROM memories, flash memories, and/or virtually any other type of electronic, optical, or mechanical memory device. Typically, memory 202 comprises more than one type of memory. For example, memory 202 may comprise a ROM memory used to store processor-executable instructions for operation of server 108, plus RAM memory to store customer account information such as award value is achieved from winning outcomes of game tickets or game cards in account for each consumer that is registered to receive award values from server 108. Communication interface 204 is electronically coupled to processor 200 and comprises electronic circuitry necessary for server 108 to communicate with server 106 and, ultimately, personal communication devices. Typically, communication interface 204 comprises hardware, software and/or firmware necessary to transmit and receive information sent via one or more commonly-used network protocols, such as the well-known TCP/IP suite of protocols. Alternatively, or in addition, communication interface could comprise electronics and supporting software/firmware to support other well-known communication types, including Wi-Fi, Bluetooth, wireless telephone communications, fiber-optic communications, and so on. User interface 206 is coupled to processor 200 and is used to allow an individual to control operation of server 108 and/or to receive information from server 108. User interface 206 may comprise one or more keyboards, touchscreen devices, pushbuttons, switches, sensors, keypads, and/or microphones that generate electronic signals for use by processor 200 upon initiation by a user. User interface 206 may additionally comprise one or more display devices, seven-segment displays, cathode ray tubes (CRTs), liquid crystal displays (LCDs), light emitting diode displays (LEDDs), light emitting diodes (LEDs), light arrays, or any other type of visual display. Further, user interface 206 could alternatively or in addition comprise an audio device, such as a speaker, for audible presentation of information to a user. Of course, the aforementioned items could be used alone or in combination with each other and other devices may be alternatively, or additionally, used.

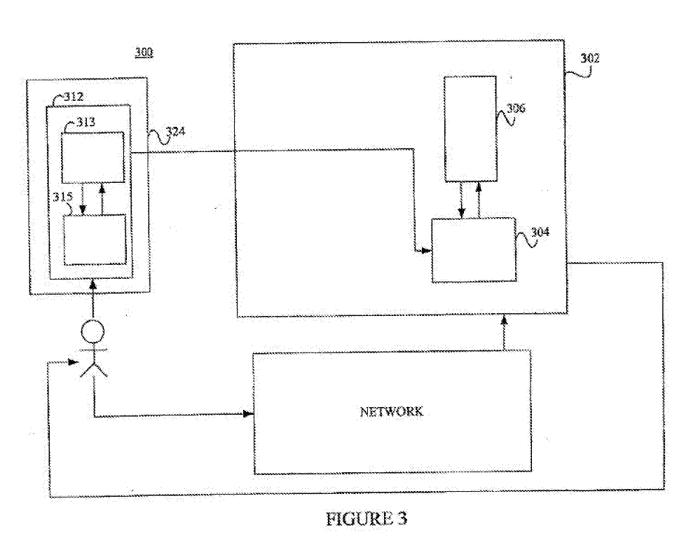

FIG. 3 is a functional block diagram of one embodiment of one of the personal communication devices 100 shown in FIG. 1. Specifically, FIG. 3 shows processor 300, memory 302, communication interface 304, and user interface 306. It should be understood that the functional blocks may be connected to one another in a variety of ways and that not all functional blocks necessary for operation of personal communication device are shown (such as a power supply), for purposes of clarity. Processor 300 provides general operation of personal communication device 100 by executing processor-executable instructions stored in memory 302, for example, executable code. Processor 300 typically comprises a general purpose processor, such as Tegra 2 processor manufactured by Nvidia Corporation of Santa Clara, Calif., although any one of a variety of microprocessors, microcomputers, and/or microcontrollers may be used alternatively. Memory 302 comprises one or more information storage devices, such as hard drives, RAM memories, ROM memories, flash memories, and/or virtually any other type of electronic, optical, or mechanical memory device. Typically, memory 302 comprises more than one type of memory. For example, memory 302 may comprise a ROM memory used to store processor-executable instructions for operation of personal communication device 100, plus RAM memory to store executable code used to allow a user to order goods or services, such as food, drink, music, videos, games, etc. Communication interface 304 is electronically coupled to processor 300 and comprises electronic circuitry necessary for personal communication device 100 to communicate, ultimately, with server 108.

Typically, communication interface 304 comprises hardware, software and/or firmware necessary to transmit and receive information sent via one or more commonly-used network protocols, such as the well-known TCP/IP suite of protocols. Alternatively, or in addition, communication interface could comprise electronics and supporting software/firmware to support a variety of well-known communication types, such as CDMA, TDMA, GSM, Ethernet, Wi-Fi, Bluetooth, fiber-optic communications, and so on. User interface 306 is coupled to processor 300 and is used to allow customers to enter and receive information related to the purchase of goods or services from merchant 102 or a number of other merchants and to receive information regarding rewards points that have been accumulated from previous purchases. User interface 306 may comprise one or more touchscreens, pushbuttons, switches, sensors, keypads, and/or microphones that generate electronic signals for use by processor 300 upon initiation by a user. User interface 306 may additionally comprise one or more liquid crystal displays (LCDs), one or more light emitting diode displays (LEDDs), one or more light emitting diodes (LEDs), light arrays, or any other type of visual display. Further, user interface 306 could, alternatively or in addition, comprise an audio device, such as a speaker, for audible presentation of information to customers. Of course, the aforementioned items could be used alone or in combination with each other and other devices may be alternatively, or additionally, used. Typically, input device 306 comprises a widely-known touchscreen device capable of displaying information and receiving user input.

A consumer may access the user interface of a loyalty platform to control loyalty program parameters other than the nature of the qualifying act. For example, a user may log onto the user interface to determine the identity of the benefit/reward for which he or she is eligible. Thus in accordance with certain embodiments, the user may elect to receive a single, specific benefit, or may select a benefit or a type of benefit from an array of choices such as listed in a catalog. Utilizing the user interface, the user could also determine the particular source of the benefit (i.e. from a particular merchant or manufacturer). Embodiments in accordance with the present invention may even leverage off of existing fields or functionality available to a particular payment processing network, in order to execute the loyalty program. For example, the VisaNet™ payment processing network is configured to include a “reservation file” capability. This capability can be utilized to allow an issuer or other entity to send a file containing individual records that each contain business rules to establish a loyalty offer for individual card numbers. Alternatively, a channel other than VisaNet™ payment messages can be used to transmit the user selections of rewards parameters to a loyalty platform, with separate file types defined for receiving this information delivered via another, secure channel.

Another example of a game ticket technology is with respect to competition in individual player sports, such as tennis, bowling or golf, which tickets may be selected by players according to their sports interests. For example, in a sports gaming ticket, using golf as an example, there are anywhere from 50 players to 200+ plus players in a tournament. The random number generator will assign numbers (or symbols to each player) and randomly select one or (preferably) more players (as complete or partial provision of selectable sports game event outcomes), such as four to ten players. Individual players may be weighted in their random selection (as indicated above), with higher favored players given lower probabilities of being randomly drawn. Awards may also be tailored to the game events.

5D is a partially completed scorecard for the virtual foursome at a tournament.

FIG. 6 is a screen shot of an electronically transmitted award based on a fictitious baseball game event. The ticket contains, for example, a random selection of nine players for a virtual team, one player at each position, with a different sports metric for each player. The players do not have to actually be on the same team or league. At the end of the game or inning (the selection may even be made mid-inning or mid-game, when partial scores of players are known), the individual grids are resolved as successfully meeting or exceeding the metric (e.g., at least two base hits for a player) and lines on the grid are resolved. If they achieve different levels indicated on the card for at least one 3-frame line, the indicated prize is won. By allowing the distal processor to randomly select players/teams, even while games are going on, or in the case of a day's series of games (as on a college football, Saturday), random games and random outcomes may even be selected during or after the games. Therefore, “real-time” has a potential content of reaching back into recent events as well as extending forward as indicated earlier herein. As long as the selections are random, including both target “points” and/or events, the system exhibits a fair offer to users/customers.

A random game ticket is provided, with an optional weighting of the type of game card provided by player selection such as “football game card,” NBA game card, SEC football game card, PGA golf card, NHL hockey card, etc. The client (which is the prize provider/manufacturer/sports league, etc.) selects the type of promotion that is to be offered. The client sets parameters for the consumer (card distributor) code. The consumer participates in the service and receives a code for using the ticket award provision system over a given time period. The consumer then asks for individual random event game card by accessing code and sends code to distal server. The game card is electronically randomly generated, either as a printed physical card, virtual electronic card sent to and stored on a mobile device (pad, phone, PC, laptop, etc.) or a terminal (even a wagering terminal where allowed). Upon conclusion of all game events within the “real-time” period allotted to the card, the point/outcome events are provided to the distal server. The distal server then resolves winning outcomes and losing outcomes on the cards. Where the cards are virtual cards, the server can directly notify the card-holder through the on-line electronic device storing the virtual card. Where printed tickets are provided, the tickets may be scanned (e.g., through bar code, QR, etc.) and outcomes verified. Or a central display at the ticket-providing site can display winning ticket numbers, such as “Patron 736, card number A-726-BP-36 is a WINNER.”

Partial winners, or random winners such as another FREE TICKET can be provided as an outcome. Other options and steps can be practiced within the scope of the generic descriptions and enablement provided herein without necessarily going outside the scope of the claimed generic invention. The game may be played as a non-wagering, social event game, parlor game, drinking game or other party game.

A further general discussion of the technology includes players receiving multiple sports outcome predictions and arranging those predictions within a square grid (for example, a 3×3 grid). These wagers could relate to any sports metric that is obtainable as real life information (e.g., it would not be based on an imaginary game or a statistic that is not normally reported (e.g., the average bat speed of a baseball player during swings at curve balls). The outcome of the sports metrics can come from single games, single sports, multiple games or multiple sports in a single game.

This wager could be made on paper at a sports book, on a specially designed kiosk, on an App for a mobile digital device, at a player terminal, at a table console, or through a website. Hand marked pre-printed grids can be hand-marked, scanned and read for selected frames, if desired.

Players arrange their different predictions onto the grid, for example strategically placing their best or strongest wager in the center square. The process of assigning each wager to a specific square could be accomplished by marking choices on a piece of paper, dragging the prediction to the specified spot on a virtual ticket, clicking or tapping on the prediction and then tapping on the desired space on the grid, using button or joystick controls to identify a frame in the grid and the selected prediction for that frame, etc.

As the sport event outcomes and metrics are finalized, the winning wagers on the grid may be illuminated or a physical ticket scanned and validated. If multiple illuminated wagers on the ticket form a specified pattern (such as one complete horizontal, vertical, or diagonal line), the ticket pays according to a paytable. The more lines that are completed on the ticket, the greater the payout. If the entire grid is illuminated, the ticket may payout a bonus progressive jackpot.

### Example

A player at a kiosk with a processor and a printer chooses nine separate football games for a week of regular season play and selects their predicted winner for each game.

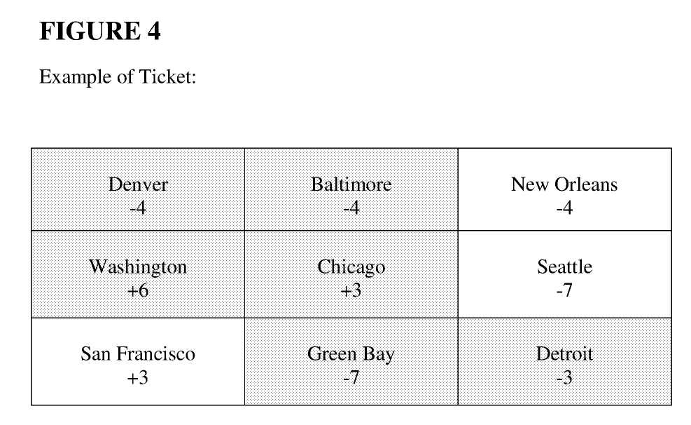

The player then arranges those games onto a 3×3 grid, placing the choice they feel strongest about in the center square. This ticket is shown in FIG. 4.

At the conclusion of the week, the ticket is assessed. If a combination of winning teams on the ticket create a complete line (or some other specified pattern), the ticket pays according to a paytable.

A system for executing a wagering event based upon game tickets to players providing a wager to a game administrator, the system comprising:

a) a player input control for determining an amount of a wager to be placed on the wagering event;

b) a game administrator receiving and acknowledging the amount of wager placed by the player, the game administrator enabling entry of wagers through a value-in-value out system selected from the group consisting of coin entry and acceptance system, currency entry and acceptance system, ticket-in-or-ticket out entry, and credit-card entry and acceptance system; (These value-in systems may include credit storage in the processor, so that an initial total value may be entered into the system, the total amount registered by the processor, and then individual or multiple tickets paid for and then printed out by decrementing the initial total value and residual amounts of the total value after initial wagers and tickets have been made).

c) the game administrator having a display system that displays both the amount of the wager and blank game cards comprising a 3×3 grid of frames into which sports game event outcomes can be inserted;

c) the game administrator having a display system and a processor, the processor providing images of sufficient sports game outcome predictions to the player to be able to fill at least nine squares in the 3×3 grid to create a completed ticket;

d) the player directing placement of at least one of the sports game outcome predictions into a frame on the grid using then player input control;

e) the player input control being configured or the processor of the game administrator being configured to position additional ones of the sports game outcome predictions into unfilled frames in the grid;

f) the game administrator processor being in communication with a distal source of real life information regarding actual outcomes on sports game outcome metrics; and

g) the game administrator processor being configured to identify winning or losing outcomes of the wager on the completed ticket based on a comparison of the real life information and the sports game outcome predictions in frames on the grid and identifying presence of paylines of 3-frame lines as winning content identified on the completed ticket and resolving the wager based on successful achievement of at least one 3-frame payline.

The ticket may be a physical ticket printed by the system or an electronically stored virtual ticket and electronically interrogatable code on the ticket (physical or virtual ticket) identifying a specific ticket (e.g., bar code, QR code, numerical identification, smart chip, and the like) further considered as a random event identifier. The identifier for the specific ticket is intimately associated with an electromagnetically interrogatable code. The identifier, in order to conserve code availability, may have a shelf-life for retrieval.

The electromagnetically interrogatable code intimately associated with the identifier (the code on the ticket) containing communicable information relating to a random award value (the random award value based on paytables stored in memory based on correspondence with numbers, orders, series or sequences of winning outcomes on individual and collective frames on the ticket).

An intermediate entry device, particularly for physical tickets, may be used that is selected from the group consisting of a camera, scanner, radio frequency identifier or near-field communicator. The intermediate entry device configured to electromagnetically interrogate the identifier and to transmit the communicable information relating to a random award value to a distal server.

The distal server is in wired or wireless two-way communication with the intermediate entry device, the distal server capable of receiving, transmitting the communicable information from the electromagnetic interrogable code. The distal server, based on the communicable information based on the electromagnetic interrogable code is configured to identify the random award value that is transmitted to the intermediate entry device, based on the paytables. The intermediate senrty device, upon receiving the transmitted and received random award value, is configured to enable the random award value to be used for an award to be paid or credited upon surrender of the ticket at the casino or wagering establishment.

The technology will be able to function in alternative manners such as A system for executing a wagering event based upon game tickets to players providing a wager to a game administrator, the system comprising:

a) a player input control for determining an amount of a wager to be placed on the wagering event;

b) a game administrator receiving and acknowledging the amount of wager placed by the player;

c) the game administrator having a display system that displays both the amount of the wager and blank game cards comprising a 3×3 grid of frames into which sports game event outcomes can be inserted;

c) the game administrator having a display system and a processor, the processor providing images of sufficient sports game outcome predictions to the player to be able to fill nine squares in the 3×3 grid to create a completed ticket;

d) the player directing placement of at least one of the sports game outcome predictions into a frame on the grid using then player input control;

e) the player input control being configured or the processor of the game administrator being configured to position additional ones of the sports game outcome predictions into unfilled frames in the grid;

f) the game administrator processor being in communication with a source of real life information regarding actual outcomes on sports game outcome metrics; and

g) the game administrator processor being configured to identify winning or losing outcomes of the wager on the completed ticket based on a comparison of the real life information and the sports game outcome predictions in frames on the grid and identifying presence of paylines of 3-frame lines as winning content identified on the completed ticket and resolving the wager based on successful achievement of at least one 3-frame payline.

The player may be provided with a set of at least X games, wherein X≧9 and the player selects sufficient ones of the games to fill squares on the grid, and the game administrator confirms a final game ticket with game selections in specific frames of the grid. The game administrator may be a game processor, the player is offered the set of at least X games for selection on a display screen on a terminal, the player fills the grid with game from the at least X games, and a verified game ticket is issued to the player. The verified game ticket may be a physically printed game ticket with a verifiable identity, which can be established by interrogatable code. The verified game ticket may be an electronic game ticket transferred from the game processor into a stored electronic file controlled by the player. The player may control the game ticket on a player-owned or player-leased microprocessor with memory.

An alternative method of providing physical game tickets to players providing a wager to a game administrator may include:

a) a player providing a wager to a game administrator through a value-in-ticket-out system;
b) the game administrator providing physical game cards comprising a 3×3 grid of frames into which sports game event outcomes have been inserted as follows:
i) the game administrator providing sufficient sports game outcome predictions to the player to be able to fill nine squares in the 3×3 grid to create a completed ticket;
ii) the player directing placement of at least one of the sports game outcome predictions into a frame on the grid; and
iii) the player or the game administrator positioning additional ones of the sports game outcome predictions into unfilled frames in the grid; and
   c) a printer printing out a completed ticket with the nine squares filled with individual and different sports game outcome predictions;
   d) the game administrator receiving real life information regarding actual outcomes on sports game outcome metrics; and
   g) the game administrator identifying winning or losing outcomes of the wager on the completed ticket based on a comparison of the real life information and the sports game outcome predictions in frames on the grid and identifying presence of paylines of 3-frame lines as winning content identified on the completed ticket and resolving the wager based on successful achievement of at least one 3-frame payline.

In the above method, after g), the game ticket is provided with electromagnetically interrogatable code and after g), the electromagnetically interrogatable code is read by a scanner, camera, bar code reader, RFID reader, QR code reader, or near-field communication reader, which identifies the sports game outcome predictions in the frames of the completed ticket, and the game administrator compares the sports game outcome predictions in the frames of the completed ticket with the real life information and the paytables to determine an amount of a winning outcome, and then displaying the amount of the winning outcome on a visual display.

The printer will be associated with, if not embedded in a stand-alone kiosk or video gaming apparatus, so that electronically generated and viewed ticket distributions in the grids can be printed out and removed.

What is claimed:

1. A method of providing game tickets to players providing a wager to a game administrator comprising: a) a player providing a wager to a game administrator; b) the game administrator providing game cards comprising a 3×3 grid of frames into which sports game event outcomes can be inserted; c) the game administrator providing sufficient sports game outcome predictions to the player to be able to fill nine squares in the 3×3 grid to create a completed ticket; d) the player directing placement of at least one of the sports game outcome predictions into a frame on the grid; e) the player or the game administrator positioning additional ones of the sports game outcome predictions into unfilled frames in the grid; f) the game administrator receiving real life information regarding actual outcomes on sports game outcome metrics; and g) the game administrator identifying winning or losing outcomes of the wager on the completed ticket based on a comparison of the real life information and the sports game outcome predictions in frames on the grid and identifying presence of paylines of 3-frame lines as winning content identified on the completed ticket and resolving the wager based on successful achievement of at least one 3-frame payline.

2. The method of claim 1 wherein the sports game event outcomes are sports event outcomes or statistics.

3. The method of claim 2 wherein the player provides input to the game administrator on selection of at least one sports game event outcome within h) a general field of sports events, and i) particular game in a field of sports and the processor then provides the player with at least one sports game outcome prediction within the selected field or particular game.

4. The method of claim 3 wherein the user selects a general field selected from the group consisting of football, basketball, baseball, hockey, soccer, golf, horse racing, automobile racing and tennis.

5. The method of claim 1 wherein the game administrator is a processor that has a player input and a ticket printer for physically printing the completed ticket.

6. The method of claim 1 wherein the game administrator is a processor that has a player input system on a terminal or hand-held wireless communication device or a tabletop game system in a cabinet, and the completed ticket is a virtual ticket displayed on a display screen and stored in memory of both the processor and memory dedicated to the player input system.

7. The method of claim 1 wherein the player is provided with nine sports game outcome predictions, and the player inserts one different sports game outcome prediction into each one of the frames in the 3×3 grid.

8. The method of claim 1 wherein the player is provided with nine sports game outcome predictions, and the player inserts at least one different sports game outcome prediction into at least one of the frames in the 3×3 grid.

9. The method of claim 7 wherein the player resolves the randomly awarded game ticket by online communication to the processor after conclusion of the random event outcomes, which random event outcomes must occur within ±12 hours of a completed ticket being provided, and resolution of winning outcomes is provided by the processor as online downloadable or printable coupons that are redeemable.

10. A system for executing a wagering event based upon game tickets to players providing a wager to a game administrator, the system comprising:
a) a player input control for determining an amount of a wager to be placed on the wagering event;
b) a game administrator receiving and acknowledging the amount of wager placed by the player;
c) the game administrator having a display system that displays both the amount of the wager and blank game cards comprising a 3×3 grid of frames into which sports game event outcomes can be inserted;
c) the game administrator having a display system and a processor, the processor providing images of sufficient sports game outcome predictions to the player to be able to fill nine squares in the 3×3 grid to create a completed ticket;
d) the player directing placement of at least one of the sports game outcome predictions into a frame on the grid using then player input control;
e) the player input control being configured or the processor of the game administrator being configured to position additional ones of the sports game outcome predictions into unfilled frames in the grid;
f) the game administrator processor being in communication with a source of real life information regarding actual outcomes on sports game outcome metrics; and
g) the game administrator processor being configured to identify winning or losing outcomes of the wager on the completed ticket based on a comparison of the real life information and the sports game outcome predictions in frames on the grid and identifying presence of paylines of 3-frame lines as winning content identified on the completed ticket and resolving the wager based on successful achievement of at least one 3-frame payline.

11. The method of claim 1 wherein the player is provided with a set of at least X games, wherein X≧9 and the player selects sufficient ones of the games to fill squares on the grid, and the game administrator confirms a final game ticket with game selections in specific frames of the grid.

12. The method of claim 11 wherein the game administrator is a game processor, the player is offered the set of at least X games for selection on a display screen on a terminal, the player fills the grid with game from the at least X games, and a verified game ticket is issued to the player.

13. The method of claim 12 wherein the verified game ticket is a physically printed game ticket with a verifiable identity.

14. The method of claim 12 wherein the verified game ticket is an electronic game ticket transferred from the game processor into a stored electronic file controlled by the player.

15. The method of claim 14 wherein the player controls the game ticket on a player-owned or player-leased microprocessor with memory.

16. A method of providing physical game tickets to players providing a wager to a game administrator comprising:
a) a player providing a wager to a game administrator through a value-in-ticket-out system;
b) the game administrator providing physical game cards comprising a 3×3 grid of frames into which sports game event outcomes have been inserted as follows:
i) the game administrator providing sufficient sports game outcome predictions to the player to be able to fill nine squares in the 3×3 grid to create a completed ticket;
ii) the player directing placement of at least one of the sports game outcome predictions into a frame on the grid; and
iii) the player or the game administrator positioning additional ones of the sports game outcome predictions into unfilled frames in the grid; and
c) a printer printing out a completed ticket with the nine squares filled with individual and different sports game outcome predictions;
d) the game administrator receiving real life information regarding actual outcomes on sports game outcome metrics; and
g) the game administrator identifying winning or losing outcomes of the wager on the completed ticket based on a comparison of the real life information and the sports game outcome predictions in frames on the grid and identifying presence of paylines of 3-frame lines as winning content identified on the completed ticket and resolving the wager based on successful achievement of at least one 3-frame payline.

16) The method of claim 15 wherein after g), the game ticket is provided with electromagnetically interrogatable code and after g), the electromagnetically interrogatable code is read by a scanner, camera, bar code reader, RFID reader, QR code reader, or near-field communication reader, which identifies the sports game outcome predictions in the frames of the completed ticket, and the game administrator compares the sports game outcome predictions in the frames of the completed ticket with the real life information and the paytables to determine an amount of a winning outcome, and then displaying the amount of the winning outcome on a visual display.
